(19) United States
(12) Patent Application Publication
(10) Pub. No.: US 2026/0214713 A1
(43) Pub. Date: Jul. 23, 2026

(54) EHT UHR DYNAMIC MULTI-LINK SWITCHING IN WIRELESS COMMUNICATIONS

(71) Applicant: MEDIATEK INC., Hsinchu City (TW)

(72) Inventors: Yongho SEOK, San Jose, CA (US); James Chih-Shi YEE, San Jose, CA (US); Weisung TSAO, San Jose, CA (US); Po-Yuen CHENG, San Jose, CA (US)

(21) Appl. No.: 19/158,189

(22) PCT Filed: Mar. 29, 2024
(86) PCT No.: PCT/CN2024/084867

§ 371 Date: Aug. 20, 2025

Related U.S. Application Data
(60) Provisional application No. 63/492,789, filed on Mar. 29, 2023.
(60) Provisional application No. 63/502,934, filed on May 18, 2023.

(51) Int. Cl. H04W 74/0816; H04W 28/02; H04W 74/08

(52) U.S. Cl. CPC H04W 74/0816; H04W 28/0278; H04W 74/0875

(57) ABSTRACT

Various techniques and schemes pertaining to ultra-high reliability (UHR) non-primary channel access in wireless communications are described. An apparatus, functioning as a station (STA) affiliated with a multi-link device (MLD), switches from listening on a primary channel to an auxiliary primary channel. The apparatus then communicates on the auxiliary primary channel.

### CROSS REFERENCE TO RELATED PATENT APPLICATION(S)

The present disclosure is part of a non-provisional patent application claiming the priority benefit of U.S. Provisional Patent Application Nos. 63/492,789 and 63/502,934, filed 29 Mar. 2023 and 18 May 2023, respectively, the contents of which being herein incorporated by reference in their entirety.

### TECHNICAL FIELD

The present disclosure is generally related to wireless communications and, more particularly, to ultra-high reliability (UHR) non-primary channel access in wireless communications.

### BACKGROUND

Unless otherwise indicated herein, approaches described in this section are not prior art to the claims listed below and are not admitted as prior art by inclusion in this section.

In a wireless local area network (WLAN) according to legacy Institute of Electrical and Electronics Engineers (IEEE) 802.11 specifications, only one 20 MHz primary channel is used by a station (STA) to determine whether channel access is available, even if a wider bandwidth (e.g., 320 MHz) might be available. That is, the STA would detect activities on the 20 MHz primary channel and determine whether to use the entire bandwidth based on a result of the detection. This may potentially leave a lot of unused bandwidth underutilized. Accordingly, it would be beneficial to be able to use the underutilized bandwidth for channel access, thereby reducing latency and improving throughput. Therefore, there is a need for a solution of UHR non-primary channel access in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to UHR non-primary channel access in wireless communications. It is believed that, under various proposed schemes in accordance with the present disclosure, issue(s) described herein may be addressed.

In one aspect, a method may involve a STA switching from listening on a primary channel to a non-primary or auxiliary primary channel (e.g., responsive to a condition existing). The method may also involve the STA communicating on the auxiliary primary channel.

In another aspect, an apparatus may include a transceiver configured to communicate wirelessly. The apparatus may also include a processor coupled to the transceiver. The processor may switch from listening on a primary channel to an auxiliary primary channel responsive to a condition existing. The processor may also communicate on the auxiliary primary channel.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial loT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UHR non-primary channel access in wireless communications. According to the present disclosure, a number of possible solutions may be implemented separately or jointly. That is, although these possible solutions may be described below separately, two or more of these possible solutions may be implemented in one combination or another.

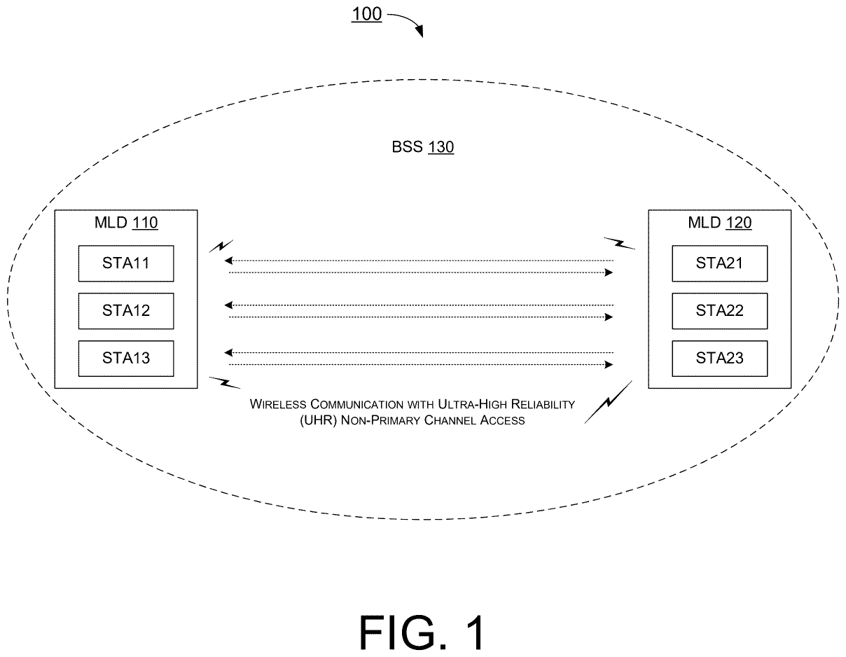

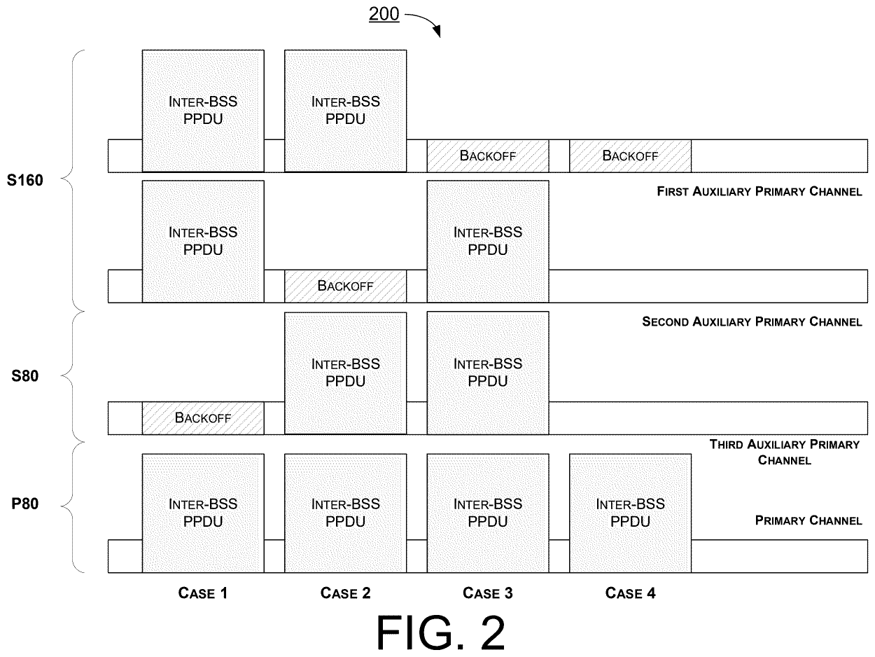

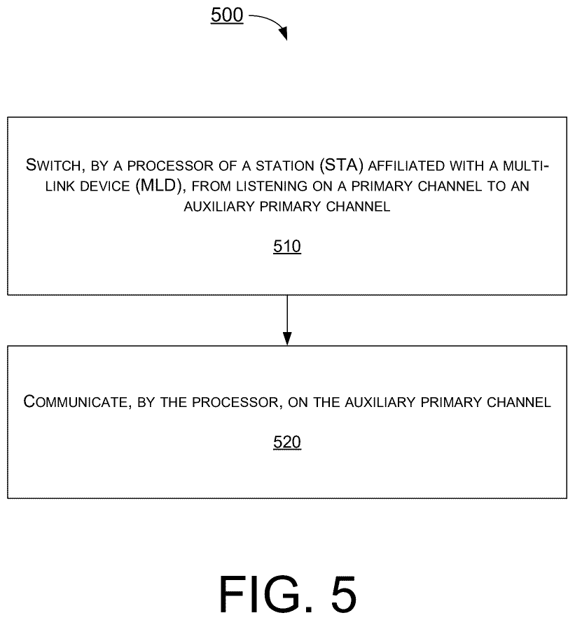

FIG. 1 illustrates an example network environment 100 in which various solutions and schemes in accordance with the present disclosure may be implemented. FIG. 2~FIG. 5 illustrate examples of implementation of various proposed schemes in network environment 100 in accordance with the present disclosure. The following description of various proposed schemes is provided with reference to FIG. 1~FIG. 5.

Referring to FIG. 1, network environment 100 may involve at least a first multi-link device (MLD), or MLD 110, and a second MLD, or MLD 120, communicating wirelessly with each other in a basic service set (BSS) 130 in accordance with one or more IEEE 802.11 standards (e.g., IEEE 802.11-2020, IEEE 802.11be and beyond). For simplicity and illustrative purposes only, each STA of multiple STAs affiliated with MLD 110 may function as an access point (AP) STA or a non-AP STA, and each STA of multiple STAs affiliated with MLD 120 may function as an AP STA or a non-AP STA. For simplicity and illustrative purposes without limiting the scope of the present disclosure, in FIG. 1, MLD 110 is shown to have three STAs (“STA11”, “STA12” and “STA13” affiliated therewith) and MLD 120 is shown to have three APs (“STA21”, “STA22” and “STA23” affiliated therewith), although in actual implementations the number of affiliated STAs/APs may be the same or different (e.g., two instead of three). Moreover, each of MLD 110 and MLD 120 may be configured to utilize various schemes of UHR non-primary channel access in wireless communications in accordance with various proposed schemes, as described below. It is noteworthy that, while the various proposed schemes may be individually or separately described below, in actual implementations each of the proposed schemes may be utilized individually or separately. Alternatively, some or all of the proposed schemes may be utilized jointly.

Under a proposed scheme in accordance with the present disclosure, when a STA (e.g., STA11) listening on a primary channel receives an inter-BSS physical layer (PHY) protocol data unit (PPDU) and sets a network allocation vector (NAV) counter from the PPDU, the STA may switch from the primary channel to one of one or more auxiliary primary channels which are non-primary channels. Under the proposed scheme, an auxiliary primary channel may be declared by a management frame sent by an AP (e.g., STA21). Correspondingly, the STA may report to the AP a switching time that is required for the STA to switch between the primary channel and the auxiliary primary channel. After switching to an auxiliary primary channel, the STA may invoke a new backoff procedure in case that the wireless medium on the auxiliary primary channel is to be sensed (e.g., by energy detection) for a certain amount of time for channel access. Moreover, auxiliary primary channel sensing of multiple auxiliary primary channels may be performed parallelly (e.g., simultaneously) or sequentially. Furthermore, after the NAV counter is expired, the AP and STA may operate on the primary channel.

Under a proposed scheme in accordance with the present disclosure, after obtaining a transmission opportunity (TXOP) on an auxiliary primary channel, a STA (e.g., STA12) may start or otherwise engage in a frame exchange of request-to-send and clear-to-send (RTS/CTS), multi-user (MU)-RTS/CTS, or buffer status report poll (BSRP) and buffer status report (BSR). The TXOP duration on the auxiliary primary channel may be less than a current NAV counter associated with the primary channel. Under the proposed scheme, after receiving a (MU-)RTS or BSRP frame on an auxiliary primary channel, a STA (e.g., STA22) may respond with a CTS or BSR frame in case one of a number of conditions is met: (1) the channel sensing (CS) of the auxiliary primary channel indicates channel idle; and (2) the peer STA (e.g., STA12) sent the (MU-)RTS frame after accessing the same auxiliary primary channel.

Under a proposed scheme in accordance with the present disclosure, when an AP (e.g., STA23) supports parallel auxiliary primary channel sensing, multiple auxiliary primary channels may be declared in a management frame transmitted by the AP. Additionally, the AP may configure the priority of the multiple auxiliary primary channels such that the auxiliary primary channel with the highest priority level among one or more idle/available auxiliary primary channels may be chosen by a STA (e.g., STA13) for channel access. In case that a STA does not support parallel auxiliary primary channel sensing, such a STA may utilize only a first auxiliary primary channel among multiple auxiliary primary channels for channel access.

FIG. 2 illustrates an example scenario 200 of non-primary channel access in accordance with an implementation of the present disclosure. In scenario 200, the total available bandwidth may be 320 MHz, including a primary 80 MHz (P80) frequency segment, a secondary 80 MHz (S80) frequency segment, and a secondary 160 MHz (S160) frequency segment. Also, in scenario 200, in addition to a 20 MHz primary channel in P80, there may be multiple (e.g., three) 20 MHz auxiliary primary channels, namely: first auxiliary primary channel in S160, second auxiliary primary channel in S160, and third auxiliary primary channel in S80.

Referring to FIG. 2, four illustrative and non-limiting example cases are shown. In a first case (Case 1), a STA (e.g., STA11) may utilize the third auxiliary primary channel because the first and second auxiliary primary channels are not available (e.g., being busy as inter-BSS PPDU has been detected on each of them), and the STA may invoke a new backoff procedure in the third auxiliary primary channel. In a second case (Case 2), the STA may utilize the second auxiliary primary channel because the first and third auxiliary primary channels are not available (e.g., being busy as inter-BSS PPDU has been detected on each of them), and the STA may invoke a new backoff procedure in the second auxiliary primary channel. In a third case (Case 3), the STA may utilize the first auxiliary primary channel because the second and third auxiliary primary channels are not available (e.g., being busy as inter-BSS PPDU has been detected on each of them), and the STA may invoke a new backoff procedure in the first auxiliary primary channel. In a fourth case (Case 4), as there are more than one auxiliary primary channel being available (idle), which auxiliary primary channel the STA utilizes depends on the situation. For example, in case that the STA does not support parallel auxiliary primary channel sensing, the STA may utilize the first auxiliary primary channel by default and invoke a new backoff procedure in the first auxiliary primary channel. As another example, in case that the STA does support parallel auxiliary primary channel sensing, the STA may utilize the first auxiliary primary channel (and invoke a new backoff procedure in the first auxiliary primary channel) in an event that the first auxiliary primary channel has the highest priority level among the first, second and third auxiliary primary channels.

Under a proposed scheme in accordance with the present disclosure, an AP (e.g., STA21) may indicate whether non-primary channel access on a direct link (e.g., for peer-to-peer communication between STAs) is allowed or not. For instance, an initial MU-RTS/BSRP trigger frame sent by the AP may indicate a list of target STAs during the TXOP. Under the proposed scheme, when a STA (e.g., STA11) listening on a primary channel receives an MU-RTS/BSRP trigger frame sent by its associated AP while the STA is not listed as one of the target STAs, the STA may switch to an auxiliary primary channel for channel access. Such auxiliary primary channel may be declared by a management frame sent by the AP. Correspondingly, the STA may report to the AP a switching time that is required for the STA to switch between the primary channel and the auxiliary primary channel. After switching to an auxiliary primary channel, the STA may invoke a new backoff procedure in case that the wireless medium on the auxiliary primary channel is to be sensed (e.g., by energy detection) for a certain amount of time for channel access. Moreover, auxiliary primary channel sensing of multiple auxiliary primary channels may be performed parallelly (e.g., simultaneously) or sequentially. Furthermore, after the NAV counter is expired, the AP and STA may operate on the primary channel.

Under a proposed scheme in accordance with the present disclosure, after obtaining a TXOP on an auxiliary primary channel, a STA (e.g., STA11) may start a frame exchange with (MU-)RTS/CTS or BSRP/BSR, with the target STA being a peer STA of the direct link. The TXOP duration on the auxiliary primary channel may be less than a current NAV counter associated with the primary channel. Under the proposed scheme, after receiving the (MU-)RTS or BSRP frame on the auxiliary primary channel, a STA (e.g., STA21) may respond with a CTS or BSR frame in case that one of a number of conditions is met: (1) the CS of the auxiliary primary channel is idle; and (2) the peer STA sent the (MU-)RTS frame after accessing the same auxiliary primary channel.

Under a proposed scheme in accordance with the present disclosure, when a STA (e.g., STA11) listens on a primary channel and detects an RTS/CTS frame exchange sent by an overlapping basic service set (OBSS) STA and sets a NAV counter from the PPDU, the STA may switch to an auxiliary primary channel which is declared by a management frame sent by an AP (e.g., STA21). After switching to the auxiliary primary channel, the STA may invoke a new backoff procedure after sensing the wireless medium on the auxiliary primary channel for a predefined amount of time. Under the proposed scheme, auxiliary primary channel sensing may be performed in parallel with primary channel sensing (e.g., before switching to the auxiliary primary channel). Alternatively, auxiliary primary channel sensing may be performed after switching to the auxiliary primary channel. Moreover, after the NAV counter is expired, the STA may switch back to the primary channel.

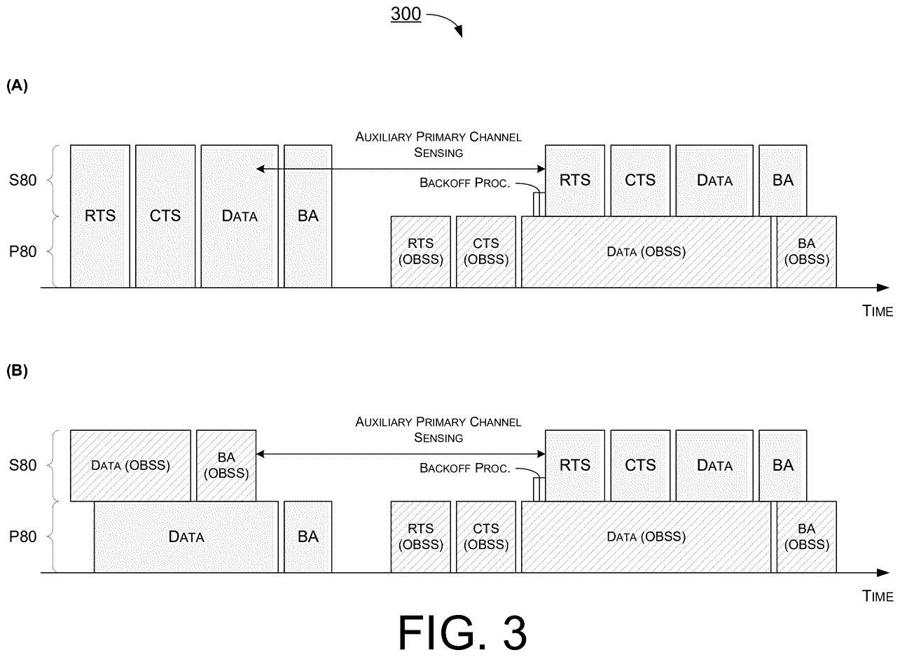

FIG. 3 illustrates an example scenario 300 of non-primary channel access in accordance with an implementation of the present disclosure. Scenario 300 pertains to illustrative and non-limiting examples of frame exchange sequence. Referring to part (A) of FIG. 3, in case that a STA (e.g., STA13) can identify the NAV status on a given auxiliary primary channel, the STA may account the channel activity during the identified duration as idle activity. After an exchange of RTS and CTS frames, the STA may transmit data and its peer STA may respond with a block acknowledgement (BA) to acknowledge receipt of the data. This may take place in either or both of the primary 80 MHz (P80 ) and secondary 80 MHz (S80 ). Moreover, in the auxiliary primary channel (e.g., S80), a backoff procedure may first be performed before the RTS/CTS exchange (followed by data and BA transmissions). Referring to part (B) of FIG. 3, in case that the STA cannot identify the NAV status on a given auxiliary primary channel, the STA may check the CS idle status (e.g., by energy detection) on the auxiliary primary channel before obtaining a TXOP on that auxiliary primary channel. After an exchange of RTS and CTS frames, the STA may transmit data and its peer STA may respond with a BA to acknowledge receipt of the data. This may take place in either or both of the P80 and S80. Moreover, in the auxiliary primary channel (e.g., S80), a backoff procedure may first be performed before the RTS/CTS exchange (followed by data and BA transmissions).

In view of the various proposed schemes and example scenarios described herein, it may be appreciable to one of ordinary skill in the art that non-primary channel access may improve throughput and reduce latency, which may be especially imperative for delay-sensitive traffic. Depending on the topology, an auxiliary primary channel sensing threshold may have an impact on the OBSS performance. For a distance with an AP operating on the auxiliary primary channel may be less than −62 dBm, a clear channel access (CCA) threshold of the auxiliary primary channel sensing may be decreased to a value below −62 dBm (or −82 dBm in the worst-case scenario). In various implementations, it may be preferable that the AP determines the CCA threshold level and announce the CCA threshold level to its associated STA(s).

### Illustrative Implementations

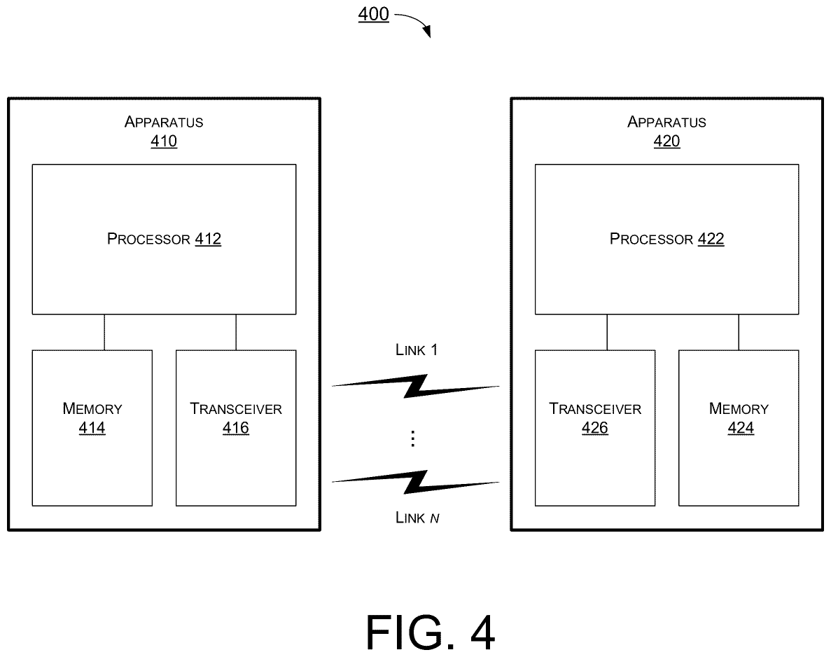

FIG. 4 illustrates an example system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to UHR non-primary channel access in wireless communications, including the various schemes described above with respect to various proposed designs, concepts, schemes, systems and methods described above as well as processes described below. For instance, apparatus 410 may be an example implementation of MLD 110, and apparatus 420 may be an example implementation of MLD 120.

Each of apparatus 410 and apparatus 420 may be a part of an electronic apparatus such as, for example and without limitation, a portable or mobile apparatus, a wearable apparatus, a wireless communication apparatus or a computing apparatus. For instance, each of apparatus 410 and apparatus 420 may be implemented in a smartphone, a smart watch, a personal digital assistant, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in a network node, such as an AP in a WLAN.

In some implementations, each of apparatus 410 and apparatus 420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, one or more RISC processors or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to UHR non-primary channel access in wireless communications in accordance with various implementations of the present disclosure.

In some implementations, apparatus 410 may also include a transceiver 416 coupled to processor 412. Transceiver 416 may be capable of wirelessly transmitting and receiving data. In some implementations, apparatus 420 may also include a transceiver 426 coupled to processor 422. Transceiver 426 may include a transceiver capable of wirelessly transmitting and receiving data. Transceiver 416 of apparatus 410 and transceiver 426 of apparatus 420 may wirelessly communicate with each other over one or more of multiple links link 1~link N, with N being a positive integer greater than 1, such as a first link and a second link.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as MLD 110, and apparatus 420, as MLD 120, is provided below in the context of example process 500. It is noteworthy that, although the example implementations described below are provided in the context of WLAN, the same may be implemented in other types of networks.

### Illustrative Processes

FIG. 5 illustrates an example process 500 in accordance with an implementation of the present disclosure. Process 500 may represent an aspect of implementing various proposed designs, concepts, schemes, systems and methods described above. More specifically, process 500 may represent an aspect of the proposed concepts and schemes pertaining to UHR non-primary channel access in wireless communications in accordance with the present disclosure. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively, in a different order. Furthermore, one or more of the blocks/sub-blocks of process 500 may be executed repeatedly or iteratively. Process 500 may be implemented by or in apparatus 410 and apparatus 420 as well as any variations thereof. Solely for illustrative purposes and without limiting the scope, process 500 is described below in the context of apparatus 410 as MLD 110 (e.g., having STA11, STA12 and STA13 affiliated therewith) and apparatus 420 as MLD 120 (e.g., having STA21, STA22 and STA23 affiliated therewith) of a wireless network such as a WLAN in accordance with one or more of IEEE 802.11 standards. Process 500 may begin at block 510.

At 510, process 500 may involve processor 412 of apparatus 410, as a STA affiliated with MLD 110 (e.g., STA11), switching, via transceiver 416, from listening on a primary channel to an auxiliary primary channel. Process 500 may proceed from 510 to 520.

At 520, process 500 may involve processor 412 communicating, via transceiver 416, on the auxiliary primary channel after switching to the auxiliary primary channel.

In some implementations, in switching to the auxiliary primary channel, process 500 may involve processor 412 switching to one or more auxiliary primary channels of a plurality of auxiliary primary channels.

In some implementations, in switching to the one or more auxiliary primary channels of the plurality of auxiliary primary channels, process 500 may involve processor 412 switching to a first auxiliary primary channel of one or more auxiliary primary channels among the plurality of auxiliary primary channels that are available. In such cases, the first auxiliary channel may have a highest priority level among priority levels of the one or more auxiliary primary channels that are available.

In some implementations, in switching to the one or more auxiliary primary channels of the plurality of auxiliary primary channels, process 500 may involve processor 412 switching to a first auxiliary primary channel of one or more auxiliary primary channels among the plurality of auxiliary primary channels that are available regardless of a priority level of each of the one or more auxiliary primary channels that are available.

In some implementations, in switching to the one or more auxiliary primary channels of the plurality of auxiliary primary channels, process 500 may involve processor 412 performing certain operations. For instance, process 500 may involve processor 412 performing auxiliary primary channel sensing on the plurality of auxiliary primary channels in parallel or sequentially. Additionally, process 500 may involve processor 412 switching to the one of the plurality of auxiliary primary channels which is determined idle based on the auxiliary primary channel sensing.

In some implementations, in communicating on the auxiliary primary channel, process 500 may involve processor 412 performing certain operations. For instance, process 500 may involve processor 412 identifying a NAV status on the auxiliary primary channel. Moreover, process 500 may involve processor 412 accounting a channel activity during an identified duration as idle activity.

In some implementations, in communicating on the auxiliary primary channel, process 500 may involve processor 412 performing other operations. For instance, process 500 may involve processor 412 checking whether a CS status is idle by energy detection on the auxiliary primary channel. Furthermore, process 500 may involve processor 412 obtaining a TXOP on the auxiliary primary channel responsive to the CS status being idle.

In some implementations, in communicating on the auxiliary primary channel, process 500 may involve processor 412 performing different operations. For instance, process 500 may involve processor 412 obtaining a TXOP on the auxiliary primary channel. Additionally, process 500 may involve processor 412 engaging in a frame exchange of RTS/CTS, MU-RTS/CTS, or BSRP/BSR. Moreover, process 500 may involve processor 412 transmitting data.

In some implementations, a duration of the TXOP on the auxiliary primary channel may be less than a current NAV counter associated with the primary channel.

In some implementations, in engaging in the frame exchange of RTS/CTS, MU-RTS/CTS or BSRP/BSR, process 500 may involve processor 412 receiving a CTS or BSR responsive to one of the following: (a) a CS status of the auxiliary primary channel being idle; and (b) the RTS, MU-RTS or BSRP being sent after the STA accessing the auxiliary primary channel.

In some implementations, in switching, process 500 may involve processor 412 switching in response to a condition existing. In such cases, the condition may include: (a) the STA listening on the primary channel and receiving an inter-BSS PPDU; or (b) the STA listening on the primary channel and receiving a (MU-)RTS or BSRP trigger from an associated AP while the STA is not listed as one of one or more target STAs.

In some implementations, process 500 may involve processor 412 performing additional operations. For instance, process 500 may involve processor 412 receiving, via transceiver 416, a management frame from an AP (e.g., an AP affiliated with MLD 120) declaring the auxiliary primary channel. Moreover, process 500 may involve processor 412 reporting, via transceiver 416, to the AP a switching time required to switch between the primary channel and the auxiliary primary channel.

In some implementations, process 500 may further involve processor 412 invoking, via transceiver 416, a backoff procedure on the auxiliary primary channel after switching to the auxiliary primary channel.

In some implementations, process 500 may further involve processor 412 switching, via transceiver 416, back to the primary channel upon expiry of a NAV counter.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds ‘true’ for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the ‘true’ scope and spirit being indicated by the following claims.

What is claimed is:

1. A method, comprising:
switching, by a processor of a station (STA) affiliated with a multi-link device (MLD), from listening on a primary channel to an auxiliary primary channel; and
communicating, by the processor, on the auxiliary primary channel.

2. The method of claim 1, wherein the switching to the auxiliary primary channel comprises switching to one or more auxiliary primary channels of a plurality of auxiliary primary channels.

3. The method of claim 2, wherein the switching to the one or more auxiliary primary channels of the plurality of auxiliary primary channels comprises switching to a first auxiliary primary channel of one or more auxiliary primary channels among the plurality of auxiliary primary channels that are available, and wherein the first auxiliary channel has a highest priority level among priority levels of the one or more auxiliary primary channels that are available.

4. The method of claim 2, wherein the switching to the one or more auxiliary primary channels of the plurality of auxiliary primary channels comprises switching to a first auxiliary primary channel of one or more auxiliary primary channels among the plurality of auxiliary primary channels that are available regardless of a priority level of each of the one or more auxiliary primary channels that are available.

5. The method of claim 2, wherein the switching to the one or more auxiliary primary channels of the plurality of auxiliary primary channels comprises:
performing auxiliary primary channel sensing on the plurality of auxiliary primary channels parallelly or sequentially; and
switching to the one of the plurality of auxiliary primary channels which is determined idle based on the auxiliary primary channel sensing.

6. The method of claim 1, wherein the communicating on the auxiliary primary channel comprises:
identifying a network allocation vector (NAV) status on the auxiliary primary channel; and
accounting a channel activity during an identified duration as idle activity.

7. The method of claim 1, wherein the communicating on the auxiliary primary channel comprises:
checking whether a channel sensing (CS) status is idle by energy detection on the auxiliary primary channel; and
obtaining a transmission opportunity (TXOP) on the auxiliary primary channel responsive to the CS status being idle.

8. The method of claim 1, wherein the communicating on the auxiliary primary channel comprises:
obtaining a transmission opportunity (TXOP) on the auxiliary primary channel;
engaging in a frame exchange of request-to-send and clear-to-send (RTS/CTS), multi-user (MU)-RTS/CTS, or buffer status report poll (BSRP) and buffer status report (BSR); and
transmitting data.

9. The method of claim 8, wherein a duration of the TXOP on the auxiliary primary channel is less than a current network allocation vector (NAV) counter associated with the primary channel.

10. The method of claim 8, wherein the engaging in the frame exchange of RTS/CTS, MU-RTS/CTS or BSRP/BSR comprises receiving a CTS or BSR responsive to one of:
a channel sensing (CS) status of the auxiliary primary channel being idle; and
the RTS, MU-RTS or BSRP being sent after the STA accessing the auxiliary primary channel.

11. The method of claim 1, wherein the switching comprises switching responsive to a condition existing, and wherein the condition comprises:
the STA listening on the primary channel and receiving an inter-basic service set (inter-BSS) physical-layer protocol data unit (PPDU); or
the STA listening on the primary channel and receiving a multi-user (MU) request-to-send (RTS) or buffer status report poll (BSRP) trigger from an associated access point (AP) while the STA is not listed as one of one or more target STAs.

12. The method of claim 1, further comprising:
receiving, by the processor, a management frame from an access point (AP) declaring the auxiliary primary channel; and
reporting, by the processor, to the AP a switching time required to switch between the primary channel and the auxiliary primary channel.

13. The method of claim 1, further comprising:
invoking, by the processor, a backoff procedure on the auxiliary primary channel after switching to the auxiliary primary channel.

14. The method of claim 1, further comprising:
switching, by the processor, back to the primary channel upon expiry of a network allocation vector (NAV) counter.

15. An apparatus, comprising:
a transceiver configured to communicate wirelessly; and
a processor coupled to the transceiver and configured to perform, as a station (STA) affiliated with a multi-link device (MLD), operations comprising:
switching, via the transceiver, from listening on a primary channel to an auxiliary primary channel responsive to a condition existing; and
communicating, via the transceiver, on the auxiliary primary channel.

16. The apparatus of claim 15, wherein the switching to the auxiliary primary channel comprises switching to one or more auxiliary primary channels of a plurality of auxiliary primary channels.

17. The apparatus of claim 16, wherein the switching to the one or more auxiliary primary channels of the plurality of auxiliary primary channels comprises switching to a first auxiliary primary channel of one or more auxiliary primary channels among the plurality of auxiliary primary channels that are available, and wherein the first auxiliary channel has a highest priority level among priority levels of the one or more auxiliary primary channels that are available.

18. The apparatus of claim 16, wherein the switching to the one or more auxiliary primary channels of the plurality of auxiliary primary channels comprises switching to a first auxiliary primary channel of one or more auxiliary primary channels among the plurality of auxiliary primary channels that are available regardless of a priority level of each of the one or more auxiliary primary channels that are available.

19. The apparatus of claim 16, wherein the switching to the one or more auxiliary primary channels of the plurality of auxiliary primary channels comprises:
performing auxiliary primary channel sensing on the plurality of auxiliary primary channels parallelly or sequentially; and
switching to the one of the plurality of auxiliary primary channels which is determined idle based on the auxiliary primary channel sensing.

20. The apparatus of claim 15, wherein the communicating on the auxiliary primary channel comprises:
obtaining a transmission opportunity (TXOP) on the auxiliary primary channel;
engaging in a frame exchange of request-to-send and clear-to-send (RTS/CTS), multi-user (MU)-RTS/CTS, or buffer status report poll (BSRP) and buffer status report (BSR); and
transmitting data,
wherein a duration of the TXOP on the auxiliary primary channel is less than a current network allocation vector (NAV) counter associated with the primary channel.
